(19) United States
(12) Patent Application Publication
(10) Pub. No.: US 2019/0257923 A1
(43) Pub. Date: Aug. 22, 2019

(54) OPTICAL STRUCTURE FOR EXTENDING LASER RADAR SCANNING RANGE OF UAVS AND OTHER OBJECTS, AND ASSOCIATED SYSTEMS AND METHODS

(71) Applicant: SZ DJI TECHNOLOGY CO., LTD., Shenzhen (CN)

(72) Inventors: Jiebin Xie, Shenzhen (CN); Wei Ren, Shenzhen (CN); Zhipeng Zhan, Shenzhen (CN)

(21) Appl. No.: 16/285,079

(22) Filed: Feb. 25, 2019

Related U.S. Application Data
(63) Continuation of application No. PCT/CN2016/096970, filed on Aug. 26, 2016.

(51) Int. Cl. G01S 7/481; G01S 17/93; G05D 1/10; B64C 39/02; B64D 47/02; B64F 5/10

(52) U.S. Cl. CPC G01S 7/4815; G01S 7/4817; G01S 7/4816; G01S 17/933; B64C 2201/141; B64C 39/024; B64D 47/02; B64F 5/10; G05D 1/106

(57) ABSTRACT

Introduced here are techniques to implement an optoelectronic scanning module (e.g., a LIDAR module) that is lighter in weight and cheaper in cost than the traditional LIDAR modules, and yet still enjoy the same or similar advantages (e.g., high precision, and all weather) as the traditional LIDARs. Example embodiments of the various techniques introduced here include a scanning optoelectronic scanning module that can be carried by an unmanned movable object, such as a UAV. The scanning module further includes an optical structure coupled to the light emitting module. The optical structure is positioned to increase a beam height of the emitted light while generally maintaining a beam width of the emitted light. Moreover, the UAV can carry a motion mechanism operable to rotate the scanning module relative to the airframe about a spin axis, so that the scanning module can perform 360 degree horizontal scans.

### TECHNICAL FIELD

The present disclosure is directed generally to unmanned movable apparatuses, and more specifically, to unmanned aerial vehicles with optoelectronic scanning modules, and associated components, systems and methods.

### BACKGROUND

With their ever increasing performance and lowering cost, unmanned aerial vehicles (UAVs) are now extensively used in many fields. Representative missions include crop surveillance, real estate photography, inspection of buildings and other structures, fire and safety missions, border patrols, and product delivery, among others. To improve flight safety as well as the user's experience (e.g., by making flight controls easier), it is important for UAVs to be able to detect obstacles independently and/or to automatically engage in evasive maneuvers. Laser radar (LIDAR) is a reliable and stable detection technology because it is able to function under nearly all weather conditions. However, traditional LIDAR devices are typically expensive and heavy, making most traditional LIDAR devices unfit for UAV applications.

Accordingly, there remains a need for improved techniques and systems for implementing LIDAR scanning modules carried by UAVs and other objects.

### SUMMARY

The following summary is provided for the convenience of the reader and identifies several representative embodiments of the disclosed techniques. An unmanned aerial vehicle (UAV) apparatus in accordance with a representative embodiment includes a main body, a scanning element carried by the main body, and a motion mechanism coupled between the main body and the scanning element. The motion mechanism is operable to rotate the scanning element relative to the main body about a spin axis. The scanning element can include a light emitting module positioned to emit light. The scanning element can further include a light sensing module positioned to detect a reflected portion of the emitted light. The scanning element can further include an optical structure coupled to the light emitting module and positioned to increase a beam height of the emitted light while generally maintaining a beam width of the emitted light.

In some embodiments, the light sensing module includes a number of light sensors, and the number of light sensors in the light sensing module can be greater than a number of light emitters in the light emitting module. Some embodiments provide that a heightwise field of view of an individual light sensor included in the light sensing module can be narrower than the increased beam height of the emitted light.

Depending on the embodiment, the optical structure can include a plano concave cylindrical lens. The optical structure can further include a plano convex lens situated between the plano concave cylindrical lens and the light emitting module. In various implementations, a flat side of the plano convex lens can face toward the light emitting module. Additionally, a flat side of the plano concave cylindrical lens can also face toward the light emitting module. According to one or more embodiments disclosed herein, the plano convex lens, the plano concave cylindrical lens, and the light emitting module can be positioned to cause a virtual image point of the light emitting module, formed from the plano convex lens, to fall within a distance corresponding to a rear focal distance of the plano concave cylindrical lens.

In one or more embodiments, a heightwise beam angle of the emitted light is increased by the optical structure from about 1 to 2 degrees to more than 30 degrees. In a number of implementations, a heightwise beam angle of the emitted light is increased by the optical structure by 10 times, and in some examples, more than 30 times. In some variations, a heightwise beam angle of the emitted light is increased by the optical structure from about 1 degree to about 33 degrees, and the a widthwise beam angle of the emitted light is to remain about less than 2 degrees. According to certain embodiments, a heightwise field of view of an individual light sensor included in the light sensing module is about 10 degrees. The heightwise fields of view of multiple light sensors included in the light sensing module can be arranged so as not to overlap each other, for example.

In some examples, the scanning element is coupled to an actuator to spin continuously at a generally constant rate. For example, the scanning element can be coupled to an actuator to spin at approximately 10 to 20 revolutions per second. The scanning element includes a scanner, which can be a light detection and ranging (LIDAR) system. The LIDAR system can include, for example, a semiconductor laser diode configured to emit light at a pulse rate of approximately 1000 Hz or 3600 Hz. In some implementations, the LIDAR system includes a single-line laser emitter.

The scanning element can further include a scanning platform that carries the scanner. In various examples, the scanner is configured to perform a terrestrial survey, obstruction detection, or a combination thereof. Further, the UAV can include a controller with instructions that, when executed, maneuver the UAV in response to terrain or an obstacle detected by the scanner. The light emitting module, in certain embodiments, can include an infrared (IR) light emitting diode (LED), and the light sensing module can include a photodiode.

In a number of embodiments, the light sensing module includes an array of light sensors. The vehicle can further include a controller configured to estimate a first distance between the vehicle and a detected obstacle based on output from a select one (e.g., the centermost) light sensor among the array of light sensors. Then, the controller can adjust a sensitivity of one or more light sensors based on the estimated first distance. In particular embodiments, a sensitivity for a light sensor located closer to an edge of the array of light sensors can be increased.

In one or more embodiments, the scanning element is weight balanced relative to the spin axis.

Several embodiments of the present disclosure also include a controller configured to maneuver the vehicle in response to the terrain or an obstacle detected by a sensor carried by the scanning element. Some of the embodiments disclosed herein can further include a plurality of thrusters carried by the main body and positioned to maneuver the vehicle in response to inputs from the controller. The plurality of thrusters can include airfoils, e.g., four propellers.

Further, in a number of examples, the vehicle includes a radio frequency module configured to receive scanning commands from a remote controlling device.

Still a further embodiment includes a method of manufacturing any and all combinations of the devices described above.

### BRIEF DESCRIPTION OF THE DRAWINGS

FIG. 1A is a schematic illustration of a representative system having a moveable object with elements configured in accordance with one or more embodiments of the present technology.

FIG. 1B is a schematic illustration of the movable object of FIG. 1A carrying a representative optoelectronic scanning module, in accordance with an embodiment of the present technology.

FIG. 2A is a schematic illustration of a representative motorized rotation mechanism that can rotate an optoelectronic scanning platform to scan horizontally, e.g., covering 360 degrees, in accordance with an embodiment of the present technology.

FIG. 2B is an enlarged view of a laser radar (LIDAR) light emitting module having multiple laser beam emitters used to scan vertically to cover potential obstacles at different altitudes.

FIG. 3 is a schematic illustration of a laser beam from a laser diode, the light spot of which is asymmetric in horizontal and vertical directions, in accordance with an embodiment of the present technology.

FIG. 4 includes two schematic illustrations showing the different virtual image points in horizontal and vertical directions resulting from the asymmetry illustrated in FIG. 3.

FIGS. 5A-5C illustrate a representative optical lens that can be used to implement one or more optical techniques in accordance with an embodiment of the present technology.

FIG. 6 shows a side view of an implementation of an example optical structure having two lenses in accordance with an embodiment of the present technology.

FIG. 7 shows a top view of the implementation shown in FIG. 6.

FIG. 8 shows the shape of a resulting laser beam from an example optoelectronic scanning module that implements one or more techniques in accordance with an embodiment of the present technology.

FIG. 9 is an example diagram showing a light emitting module and a light sensing module, in accordance with embodiments of the present technology.

FIG. 10 is an example diagram showing an optoelectronic scanning module, in accordance with embodiments of the present technology.

### DETAILED DESCRIPTION

It is important for unmanned aerial vehicles (UAVs) to be able to independently detect obstacles and/or to automatically engage in evasive maneuvers. Laser radar (LIDAR) is a reliable and stable detection technology because LIDAR can remain functional under nearly all weather conditions. However, traditional LIDAR devices are typically expensive and heavy, making most traditional LIDAR devices unsuitable for UAV applications.

Accordingly, the present technology is directed to techniques for implementing an optoelectronic scanning module (e.g., a LIDAR module) that is lighter weight and less expensive than the traditional LIDAR modules, and yet can still produce the same or similar advantages (e.g., high precision, and all-weather operation) as the traditional LIDARs. Example embodiments of the various techniques introduced herein include an optoelectronic scanning module that can be carried by an unmanned movable object, such as a UAV. The scanning module can include a light emitting module positioned to emit light, and a light sensing module positioned to detect a reflected portion of the emitted light. The scanning module further includes an optical structure coupled to the light emitting module. The optical structure is positioned to increase a beam height of the emitted light while generally maintaining a beam width of the emitted light. Moreover, a motion mechanism can be located between the body of the UAV and the scanning module. The motion mechanism can be operable to rotate the scanning module relative to the airframe about a spin axis, so that the scanning module can perform 360 degree horizontal scans.

In the following description, the example of a UAV is used, for illustrative purposes only, to explain various techniques that can be implemented using a LIDAR scanning module that is cheaper and lighter than the traditional LIDARs. In other embodiments the techniques introduced here are applicable to other suitable scanning modules, vehicles, or both. For example, even though one or more figures introduced in connection with the techniques illustrate a UAV, in other embodiments, the techniques are applicable in a similar manner to other type of movable objects including, but not limited to, an unmanned vehicle, a hand-held device, or a robot. In another example, even though the techniques are particularly applicable to laser beams produced by laser diodes in a LIDAR system, other types of light sources (e.g., other types of lasers, or light emitting diodes (LEDs)) can be applicable in other embodiments.

In the following description, numerous specific details are set forth to provide a thorough understanding of the presently disclosed technology. In other embodiments, the techniques introduced here can be practiced without these specific details. In other instances, well-known features, such as specific fabrication techniques, are not described in detail in order to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. Also, it is to be understood that the various embodiments shown in the figures are merely illustrative representations and are not necessarily drawn to scale.

Several details describing structures or processes that are well-known and often associated with UAVs and corresponding systems and subsystems, but that can unnecessarily obscure some significant aspects of the disclosed techniques, are not set forth in the following description for purposes of clarity. Moreover, although the following disclosure sets forth several embodiments of different aspects of the present disclosure, several other embodiments can have different configurations or different components than those described in this section. Accordingly, the introduced techniques can have other embodiments with additional elements or without several of the elements described below.

Many embodiments of the present disclosure described below can take the form of computer- or controller-executable instructions, including routines executed by a programmable computer or controller. Those skilled in the relevant art will appreciate that the introduced techniques can be practiced on computer or controller systems other than those shown and described below. The techniques introduced herein can be embodied in a special-purpose computer or data processor that is specifically programmed, configured or constructed to perform one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers and the like). Information handled by these computers and controllers can be presented at any suitable display medium, including a liquid crystal display (LCD). Instructions for performing computer- or controller-executable tasks can be stored in or on any suitable computer-readable medium, including hardware, firmware or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause and effect relationship), or both.

For purposes of discussion herein, the terms “horizontal,” “horizontally,” “vertical,” or “vertically,” are used in a relative sense, and more specifically, in relation to the main body of the unmanned vehicle. For example, a “horizontal” scan means a scan having a scan plane that is generally parallel to the plane formed by the main body, while a “vertical” scan means a scan having a scan plane that is generally perpendicular to the plane formed by the main body.

### 1. Overview

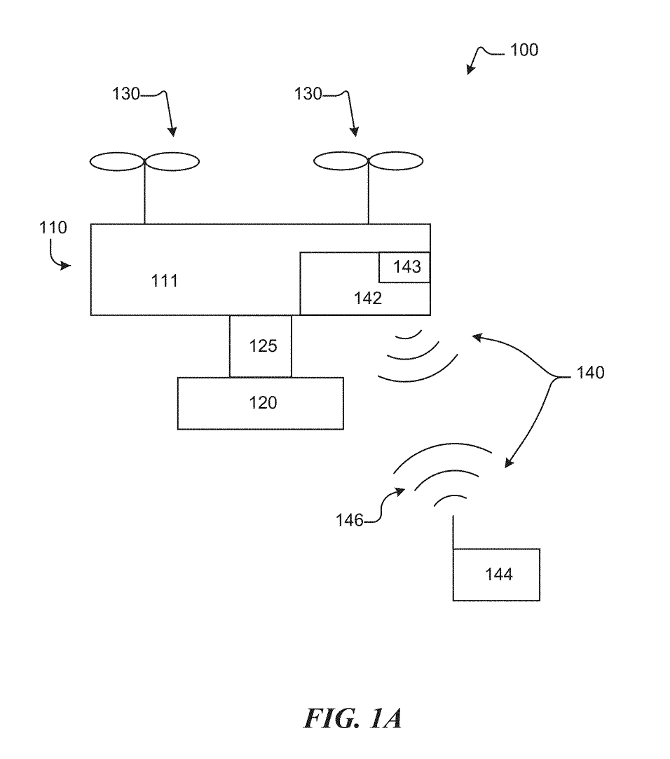

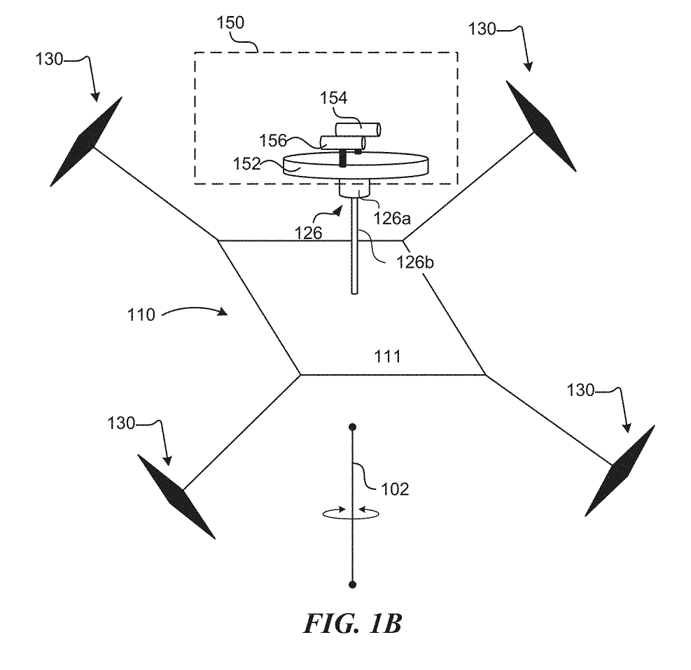

FIG. 1A is a schematic illustration of a representative system 100 having elements in accordance with one or more embodiments of the present technology. The system 100 includes a movable object 110 and a control system 140. Although the movable object 110 is depicted as an unmanned aerial vehicle (UAV), this depiction is not intended to be limiting, and any suitable type of movable object can be used in other embodiments, as described herein.

The moveable object 110 can include a main body 111 (e.g., an airframe) that can carry a payload 120, for example, an imaging device or an optoelectronic scanning device (e.g., a LIDAR device). In particular embodiments, the payload 120 can be a camera, for example, a video camera and/or still camera. The camera can be sensitive to wavelengths in any of a variety of suitable bands, including visual, ultraviolet, infrared and/or other bands. In still further embodiments, the payload 120 can include other types of sensors and/or other types of cargo (e.g., packages or other deliverables). In many of these embodiments, the payload 120 is supported relative to the main body 111 with a carrying mechanism 125. The carrying mechanism 125, in some embodiments, can allow the payload 120 to be independently positioned relative to the main body 111. For instance, the carrying mechanism 125 can permit the payload 120 to rotate around one, two, three, or more axes. In other embodiments, the carrying mechanism 125 can permit the payload 120 to move linearly along one, two, three, or more axes. The axes for the rotational or translational movement may or may not be orthogonal to each other. In this way, when the payload 120 includes an imaging device, the imaging device can be moved relative to the main body 111 to photograph, video or track a target.

In some embodiments, the payload 120 can be rigidly coupled to or connected with the movable object 110 such that the payload 120 remains generally stationary relative to the movable object 110. For example, the carrying mechanism 125 that connects the movable object 110 and the payload 120 may not permit the payload 120 to move relative to the movable object 110. In other embodiments, the payload 120 can be coupled directly to the movable object 110 without requiring the carrying mechanism 125.

One or more propulsion units 130 can enable the movable object 110 to take off, land, hover, and move in the air with respect to up to three degrees of freedom of translation and up to three degrees of freedom of rotation. In some embodiments, the propulsion units 130 can include one or more rotors. The rotors can include one or more rotor blades coupled to a shaft. The rotor blades and shaft can be rotated by a suitable drive mechanism, such as a motor. Although the propulsion units 130 of the moveable object 110 are depicted as propeller-based and can have four rotors (as shown in FIG. 1 B), any suitable number, type, and/or arrangement of propulsion units can be used. For example, the number of rotors can be one, two, three, four, five, or even more. The rotors can be oriented vertically, horizontally, or at any other suitable angle with respect to the moveable object 110. The angle of the rotors can be fixed or variable. The propulsion units 130 can be driven by any suitable motor, such as a DC motor (e.g., brushed or brushless) or an AC motor. In some embodiments, the motor can be configured to mount and drive a rotor blade.

The movable object 110 is configured to receive control commands from the control system 140. In the embodiment shown in FIG. 1A, the control system 140 includes some components carried on the moveable object 110 and some components positioned off the moveable object 110. For example, the control system 140 can include a first controller 142 carried by the moveable object 110 and a second controller 144 (e.g., a human-operated, remote controller) positioned remote from the moveable object 110 and connected via a communication link 146 (e.g., a wireless link such as a radio frequency (RF) based link). The first controller 142 can include a computer-readable medium 143 that executes instructions directing the actions of the moveable object 110, including, but not limited to, operation of the propulsion system 130 and the payload 120 (e.g., a camera). The second controller 144 can include one or more input/output devices, e.g., a display and control buttons. The operator manipulates the second controller 144 to control the moveable object 110 remotely, and receives feedback from the moveable object 110 via the display and/or other interfaces on the second controller 144. In other representative embodiments, the moveable object 110 can operate autonomously, in which case the second controller 144 can be eliminated, or can be used solely for operator override functions.

FIG. 1B schematically illustrates the moveable object 110 of FIG. 1 A carrying a representative optoelectronic scanning module (or a scanning element) 150. The scanning module 150 can be carried by a motion mechanism 126. The motion mechanism 126 can be the same as or similar to the carrying mechanism 125 for the payload 120, described above with reference to FIG. 1A. For example, as illustrated in FIG. 1B, the motion mechanism 126 includes a spinning device 126a (e.g., an electric motor) and a support rod 126b. The motion mechanism 126 is coupled between the main body of the moveable object 110 and the scanning module 150 so as to connect the two together. Further, in a number of embodiments, the motion mechanism 126 is operable (e.g., either by control from the second controller 144 (FIG. 1A) or autonomously by programming) to rotate the scanning module 150 relative to the main body about a spin axis 102, so that the scanning module 150 can perform horizontal scans (e.g., 360 degree horizontal scans).

The optoelectronic scanning module 150 can include a scanning platform 152 carrying a light emitting module 154 and a light sensing module 156. The light emitting module 154 is positioned to emit light, and the light sensing module 156 is positioned to detect a reflected portion of the emitted light. In many implementations, the optoelectronic scanning module 150 is a LIDAR module, and the light emitting module 154 includes a semiconductor laser diode (e.g., a P-I-N structured diode). The light sensing module 156 can include photodetectors, e.g., solid state photodetectors (including silicon (Si)), avalanche photodiodes (APD), photomultipliers, or combinations of the foregoing. In some implementations, the semiconductor laser diode can emit a laser light at a pulse rate of approximately 1000 Hz or 3600 Hz.

In various embodiments, the scanning module 150 can perform a three-dimensional (3D) scanning operation, covering both horizontal and vertical directions, in order to detect obstacles and/or to conduct terrestrial surveys. Objects that can be detected typically include any physical objects or structures such geographical landscapes (e.g., mountains, trees, or cliffs), buildings, vehicles (e.g., aircraft, ships, or cars), or indoor obstacles (e.g., walls, tables, or cubicles). Other objects include live subjects such as people or animals. The objects can be moving or stationary.

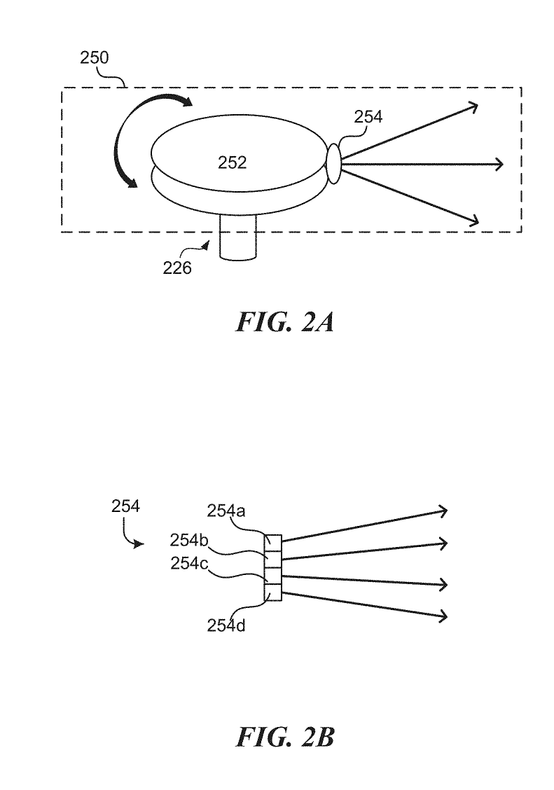

FIG. 2A shows a representative motorized rotation mechanism 226 that can rotate an optoelectronic scanning platform 252 to scan horizontally, e.g., covering 360 degrees. As discussed above, a 3D laser radar typically scans in two directions, e.g., horizontal and vertical. In the horizontal plane, an electric motor (e.g., a spinning element 126a, shown in FIG. 1B) can be used to drive the laser beams emitted by a light emitting module 254 to rotate and scan in a 360-degree range.

In the vertical plane, in order to cover potential obstacles at different altitudes, one approach is to use multiple laser beams, with each laser beam configured to cover obstacles at a different altitude. FIG. 2B shows an enlarged view of a laser radar (LIDAR) light emitting module 254 having multiple laser beam emitters 254a-254d used to scan vertically to cover potential obstacles at different altitudes. This approach requires multiple laser emitters (e.g., emitters 254a-254d) to operate simultaneously, which increases cost, power consumption, and weight of the unit.

Techniques introduced below implement an optoelectronic scanning module (e.g., a LIDAR module) that is lighter weight and less expensive than the traditional LIDAR modules, and yet still produces the same or similar advantages (e.g., high precision, and all-weather operation) as the traditional LIDARs.

More specifically, as will be described in more detail below, the techniques in accordance with the present technology can utilize a beam divergent property of a laser diode on different planes. Therefore, the disclosed embodiments can include an optical structure for controlling the shape of a laser beam in different axial directions, such that the laser beam can have a relatively large beam height while generally maintaining the beam's width. In some embodiments, the increased beam angle in the vertical (height) direction can exceed 30 degrees. For the horizontal direction, the same spinning device (e.g., the electric motor 226a) can be used to rotate the scanning module in order to complete a 360° scan in a horizontal plane. In this way, the need for a multi-line laser emitter (e.g., emitters 254a-254d) to achieve a 3D coverage is greatly reduced or even completely eliminated, thereby greatly reducing the cost, the weight, as well as the structural complexity for implementing a LIDAR scanning module on a UAV system. Embodiments of the presently disclosed LIDAR scanning modules are therefore more suitable for small to medium sized unmanned aerial vehicle applications than the traditional LIDAR scanners.

### 2. Operating Principles

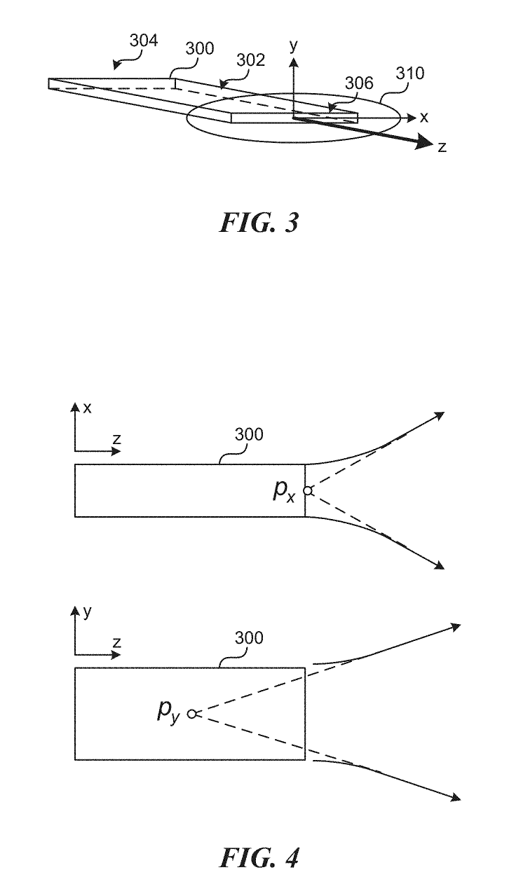

FIG. 3 is a schematic illustration of a system in accordance with an embodiment of the present technology that produces a laser beam and light spot 310 which is asymmetric in the horizontal and vertical directions. In FIG. 3, a laser diode structure 300 that produces the beam includes an active layer 302, a back facet 304 (which can be coated with a high reflection layer), and a front emission facet 306. Such a laser diode structure for LIDAR applications typically has a small form factor. The laser beam that is produced using a diode structure (e.g., the structure 300) as the gain medium is expected to be different from beams provided by conventional lasers. Among others, one prominent difference is that the resonant cavity of such a laser diode typically has a small dimension, and as a result, the resulting laser beam usually has a relatively large angle of divergence (e.g., around 10 to 20 degrees).

Furthermore, because the diode structure 300 typically has different dimensions in two mutually perpendicular directions (e.g., x and y directions, as shown in FIG. 3), the emitted laser beam typically has different angles of divergence in the two directions. That is to say, the light spot 310 of the laser beam is typically elliptical, and the asymmetry of the beam divergence in the plane parallel and perpendicular to the emitting junction of the diode structure 300 is referred to as “astigmatism.” Referring now to FIG. 4, the degree of astigmatism can be measured by the distance between the two different locations of the virtual image focal points, one in the horizontal plane (e.g., Py) and one in the vertical plane (e.g., Px). FIG. 4 shows two schematics illustrating the different virtual image focal points in horizontal and vertical directions resulting from the beam asymmetry illustrated in FIG. 3. For purposes of discussion, it is assumed here (in FIGS. 3-4 and 6-7) that the z direction is the direction of laser propagation, that the x-z plane is perpendicular to the ground (or “vertical”), and that the y-z plane is parallel to the ground (or “horizontal”).

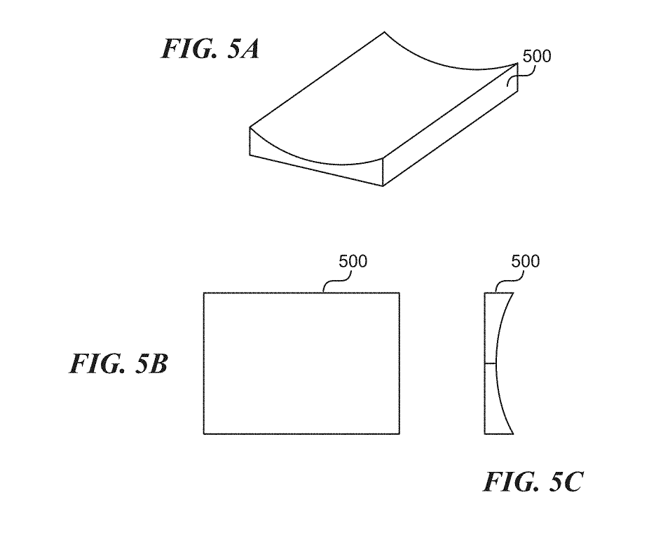

FIGS. 5A-5C illustrate a representative optical lens 500 that can be used to implement one or more of the techniques introduced here. FIGS. 5A-5C illustrate an isometric, top and end views, respectively, of the optical lens 500.

To reduce the angles of divergence discussed above, a convex lens can be used to collimate the laser beam. Specifically, a laser diode placed at the rear focal point of a convex lens can collimate the resulting laser beam that is emitted from the laser diode, e.g., produce a beam with parallel rays. However, a convex lens typically has a central symmetry, and due to the existence of astigmatism, the laser beam would not be collimated both on the x-z plane and the y-z plane by the convex lens at the same time. A cylindrical lens can be placed behind the convex lens to adjust the astigmatism, because of the cylindrical lens can have different curvatures in the two axial directions (e.g., a finite curvature in one axis, and an infinite curvature in the other axis).

Embodiments of the present disclosure can increase the difference in the degree of collimation of the laser beam, and stretch the light spot size in a desired direction but not in others. Accordingly, some embodiments include an optical structure that further adds a cylindrical lens (e.g., the optical lens 500, shown as a plano concave cylindrical lens) behind the aforementioned convex lens. Further implementation details are described below.

### 3. Representative Embodiments

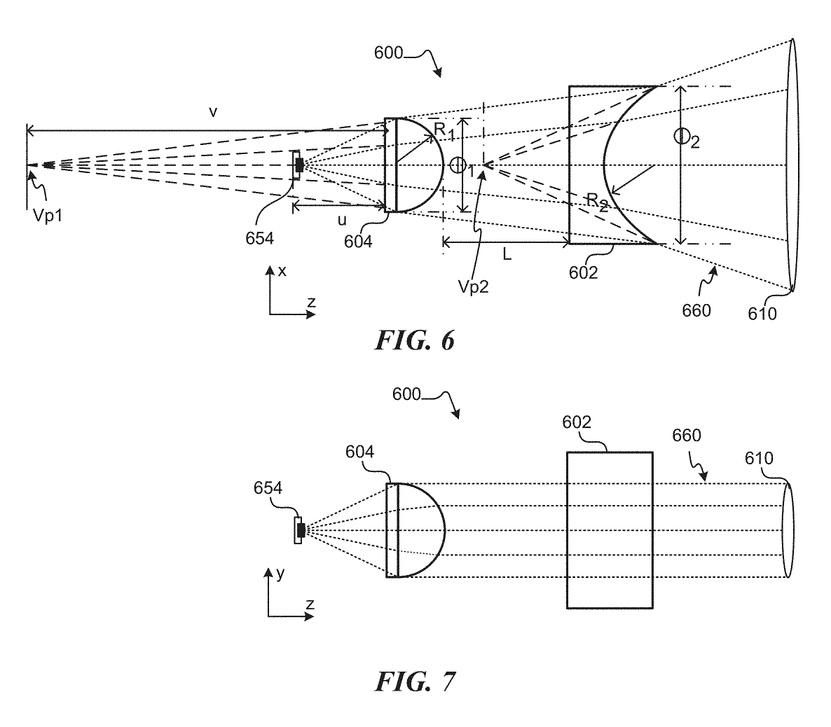

FIG. 6 shows a side view of a representative optical structure 600 having two lenses, e.g., a combination of a plano convex spherical lens 604 and a plano concave cylindrical lens 602. FIG. 7 shows a top view of the structure shown in FIG. 6. For purposes of discussion, the terms “front” and “back” are used in a relative sense; in describing FIGS. 6-7, “back” means toward the emission source of the laser light, and “front” means a direction opposite to “back.” For example, with reference to FIG. 6, the plano convex lens 604 is described as being placed in “front” of the plano concave lens 602. Note that the figures shown here are not drawn to scale.

In the structure 600 shown in FIGS. 6-7, the plano convex lens 604 has a diameter ϕ1=12.7 mm. The curvature of the plane side of the plano convex lens 604 is infinite (because the side is plane), and the curvature of the other side is R1=15 mm. In some implementations, the material for the plano convex lens 604 can be glass (e.g., Borosilicate glass) or other suitable materials. In the example optical structure 600, the plano convex lens 604 is disposed in front of the laser diode 654, with the plane surface facing the laser diode 654. The plane surface can be placed at a suitable distance from the light emitting point of the laser diode 654, e.g., at the rear focal point of the plano convex lens 604, such that the laser beam 660 on the y-z plane (FIG. 7) can be properly collimated. In some embodiments, the suitable distance u=12 mm.

Due to the existence of astigmatism, however, the virtual image point (i.e., Vp1) in the x-z plane of FIG. 6 is located in front of the virtual image point (i.e., the focal point of the plano convex lens 604, which is the location of the emitter 654) in the y-z plane of FIG. 7. That is to say, the plano convex lens 604 diverges the laser beam 660 in the x-z plane (FIG. 6), forming the virtual image point Vp1. In some embodiments, Vp1 is located at the position of v=60 mm.

Further, the plano concave cylindrical lens 602 in the optical structure 600, in one or more embodiments, is placed behind the plano convex lens 604 at a suitable distance L, for example, L=120 mm. In some embodiments, the aperture diameter of the plano concave lens 602 is ϕ2=35 mm. The curvature of the concave cylindrical side that is parallel to the x-z plane (as shown in FIG. 6) is R2, and R2=100 mm, in accordance with some embodiments. The curvature of the concave cylindrical side that is parallel to the y-z plane (as shown in FIG. 7) is infinite. Because the curvature of the concave cylindrical side of the plano concave cylindrical lens 602 in the y-z plane is infinite, the already-collimated beam does not diverge, but stays parallel.

Referring back to FIG. 6, in the x-z plane, the laser beam 660 can become even more divergent after passing the plano concave cylindrical lens 602. This is because the virtual image point Vp1 is configured to be located within the rear focal distance of the plano concave lens 602. A virtual image is thus formed at the position of the virtual image point Vp2. Accordingly, the resulting light spot 610 of the laser beam 660 has an increased beam height (in the x-z plane) while its beam width (in the y-z plane) generally remains the same.

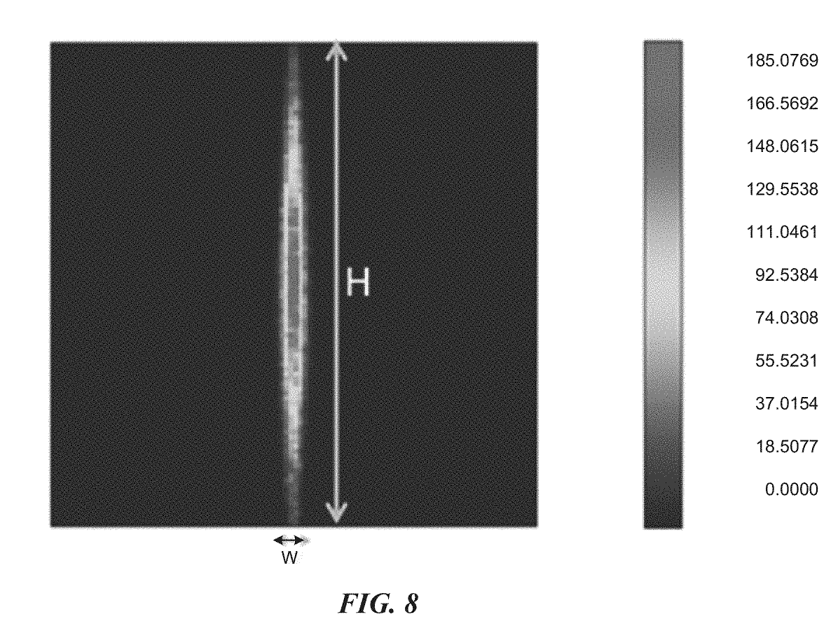

FIG. 8 shows the shape of a resulting laser beam 660 from an example optoelectronic scanning module that implements one or more of the techniques described above. Specifically, FIG. 8 shows a representative light spot resulting from the representative optoelectronic scanning module and optical structure described above with reference to FIGS. 6-7.

With simultaneous reference to FIGS. 6-7, in FIG. 8, at a distance about one meter away from the plano concave lens 602, the light spot 610 has an approximate height H=0.6 m (the x-z plane, perpendicular to the ground) and an approximate width W=0.04 m (the y-z plane, parallel to the ground). In other words, the beam angle covered by the light spot 610 is about 33° (H)×2° (W). The light spot of a typical light emitter (e.g., emitter 654) without the optical structure described above is about 1°˜2° in height. Therefore, embodiments of the light structure described above can increase a heightwise beam angle of the emitted light from about 1 degree to 2 degrees to more than 30 degrees. That is to say, a heightwise beam angle of the emitted light is increased by the optical structure by at least 30 times, and a widthwise beam angle of the emitted light can remain about the same (e.g., less than 2 degrees).

As described above, in accordance with embodiments of the present technology, the optical structures can change the size of a laser beam in a single dimension such that it can illuminate obstacles over a wider range of altitudes than without the optical structure. With the techniques introduced here, the need for a multi-line laser emitter (e.g., emitters 254a-254d shown in FIG. 2B) to achieve a 3D coverage is greatly reduced or even completely eliminated, thereby greatly reducing the cost, the weight, and the structural complexity for implementing a LIDAR scanning module on a UAV system.

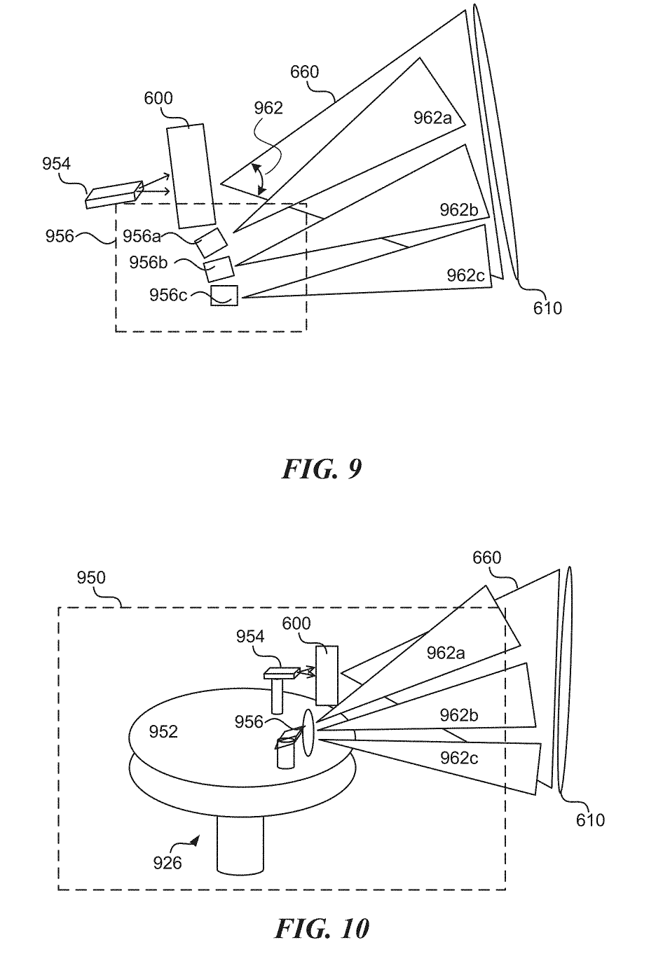

FIG. 9 is a representative diagram showing a light emitting module and a light sensing module, configured in accordance with embodiments of the present disclosure. In FIG. 9, a light emitting module 954 only includes a single laser diode and emits a single-line laser. The light emitting module 954 is fitted with an embodiment of the optical structure 600 described above, and therefore is able to produce a laser beam 660 with a wide beam angle 962 in the vertical direction (i.e., the x-z plane). In addition, the overall system can include a light sensing module 956 having an array of light sensors 956a-956c (e.g., 3 photodiodes) placed at the receiving terminal. The array of light sensors 956a-956c is parallel to the x-z plane, with each photodiode covering a field of view (FOV) of about 10 degrees (illustrated as FOV 962a, FOV 962b, and FOV 962c, respectively). Each of the light sensors 956a-956c is slightly tilted to face different directions, so that the light sensors 956a-956c can collectively detect reflected light signals in an FOV angle range of about 33 degrees in the vertical direction. That is to say, in a number of implementations, the number of light sensors in the light sensing module 956 is greater than a number of light emitters in the light emitting module 954, and a heightwise field of view (e.g., FOV 962a) of an individual light sensor included in the light sensing module can be narrower than the increased beam height of the emitted light (e.g., as illustrated by light spot 610). According to certain embodiments of the present disclosure, the heightwise fields of view (e.g., FOVs 962a-962c) of multiple light sensors (e.g., sensors 956a-956c) included in the light sensing module 956 are arranged so as not to overlap each other. In such embodiments, because the fields of view of different diodes do not overlap, the detection of a signal at a given diode corresponds to a detected object in a direction and at an altitude associated with the given diode. In other embodiments, a greater number of photodiodes in an array can generally locate reflected light with a higher degree of angular accuracy.

FIG. 10 illustrates a LIDAR system 950 that includes an optoelectronic scanning module, in accordance with embodiments of the present disclosure.

Referring to FIGS. 9 and 10 together, the light emitting module 954 (including the introduced optical structure 600) and the light sensing module 956 are installed on a scanning platform 952, and the entire platform 952 can be rotated with a motion mechanism 926 (which can include a spinning element such as an electric motor) in the horizontal direction. The motion mechanism 926 can include a control circuit (e.g., for the electric motor) that can control a rotational speed of the scanning platform 952. Depending on the embodiment, the rotational rate (or the spin rate) can be generally constant, and in some embodiments, can be set by a user. In one or more implementations, the spin rate can be set to about 10 revolutions per second (r.p.s.). A sensor (e.g., a Hall effect sensor, or a rotary encoder) can be placed on the motion mechanism 926 to provide readings of the current angular position. In particular embodiments, (e.g., embodiments where the scanning platform 952 is constantly spinning), the scanning module can be weight balanced relative to the spin axis.

An embodiment of the LIDAR system 950 shown in FIG. 10 scans using laser at a spin rate about 10 r.p.s. The laser beam is expanded vertically after passing through the optical structure 600, and the light reflected by an obstacle is detected by one or several light sensors 956a-956c in the light sensing array 956. The diodes convert the detected light to an electric signal for output. Then, the distance to the obstacle can be determined, e.g., by determining a time of travel, which is the time difference between the light being emitted and the reflected light being detected, and converting the time of travel into the distance based on an estimated light speed. Then, based on the position of the corresponding diode(s) that detected the obstacle, the orientation of the obstacle in the vertical direction can be determined. In addition, based on the angular position of the rotating electric motor when the reflected light was detected, the orientation of the obstacle in the horizontal direction can be determined. In this way, the LIDAR system 950 can be utilized in UAV systems to perform 3D scans.

The scanner can be utilized to perform a terrestrial survey, obstruction detection, or a combination thereof. In some embodiments, the controller on the UAV can be programed to maneuver the vehicle in response to terrain or an obstacle detected by the scanner. This can greatly improve flight safety as well the user's experience (e.g., by reducing the difficulty of controlling the flight) of the UAV system.

Depending on the embodiment, some of the optical structures disclosed herein can create a distribution of light intensity across the laser beam height (e.g., as shown in FIG. 8). Accordingly, the output from the light sensors can be adjusted to account for the distribution in order to increase the accuracy and uniformity of the scans. For example, a controller can be programed to perform an initial estimation of a first distance between the vehicle and a detected object. In some embodiments, this initial estimation can be based on an output from a light sensor at a select position (e.g., the centermost light sensor 956b among the array of light sensors shown in FIG. 9). Then, the controller can adjust a sensitivity of one or more light sensors based on the estimated first distance. For example, a look up table stored with the controller can be used to perform such an adjustment, or the adjustment can be performed using a formula relating sensitivity to the estimated distance. In some embodiments, the magnitude of the sensitivity adjustment is directly proportional to the estimated distance. Additionally, such a formula may have a set of parameters that are specific to the location of a given light sensor relative to the array. The adjustment can include, but need not be limited to, adjusting (e.g., increasing) a sensitivity for a light sensor located closer to an edge of the array of light sensors, because the light intensity corresponding to the fields of view of such sensors can be weaker based on the sensor position. The formula can also take into account other factors including, for example, a possible angle with which the light is reflected from the object (on which the intensity of the light received by the detector may also depend).

### 4. UAV Manufacturing Methods

Embodiments of the present disclosure also include methods of manufacturing unmanned aerial vehicles. A representative method includes installing a scanning element on an airframe. The scanning element includes a light emitting module positioned to emit light, a light sensing module positioned to detect a reflected portion of the emitted light, and an optical structure coupled to the light emitting module and positioned to increase a beam height of the emitted light while generally maintaining a beam width of the emitted light. The step of installing the scanning element can include coupling a motion mechanism between the airframe and the scanning element. In certain embodiments, the motion mechanism is operable to rotate the scanning element relative to the airframe about a spin axis.

In some embodiments, the method can further include placing a number of light sensors in the light sensing module, and placing a number of light emitters in the light emitting module. The number of light sensors in the light sensing module can be greater than the number of light emitters in the light emitting module. The method can further include placing a plano concave cylindrical lens in the optical structure. Some embodiments of the method further include placing a plano convex lens in the optical structure. The plano convex lens can be situated between the plano concave cylindrical lens and the light emitting module. Both a flat side of the plano convex lens and a flat side of the plano concave cylindrical lens can be facing toward the light emitting module. The plano convex lens, the plano concave cylindrical lens, and the light emitting module can be positioned to cause a virtual image point of the light emitting module, formed from the plano convex lens, to fall within a distance corresponding to a rear focal distance of the plano concave cylindrical lens.

In a number of embodiments, a heightwise beam angle of the emitted light is increased by the optical structure by at least 30 times. In some implementations, a heightwise field of view of an individual light sensor included in the light sensing module is about 10 degrees. In other examples, the heightwise fields of view of multiple light sensors included in the light sensing module are arranged so as not to overlap each other.

The method can further include coupling the scanning element to an actuator operable to spin the scanning element continuously at a generally constant rate. the scanning element can include a scanning platform that carries a scanner. The scanning element can be a light detection and ranging (LIDAR) system.

Methods accordance with various embodiments, can include installing a controller carrying instructions that maneuver the vehicle in response to an input corresponding to terrain or an obstacle detected by the scanning element. In various implementations, the method includes installing a plurality of thrusters on the airframe, the plurality of thrusters positioned to maneuver the vehicle in response to inputs from the controller. In some embodiments, the controller is further configured to estimate a first distance between the vehicle and a detected object based on output from a centermost light sensor among the array of light sensors, and adjust a sensitivity of one or more light sensors based on the estimated first distance. The adjustment can include, for example, increasing a sensitivity for a light sensor located closer to an edge of an array of light sensors. The method can further include performing weight balancing of the scanning element, relative to the spin axis. In addition, the method can include installing a radio frequency module to receive scanning commands from a remote controlling device.

### 5. Conclusion

From the foregoing, it will be appreciated that specific embodiments of the technology have been described herein for purposes of illustration, but that various modifications can be made without deviating from the technology. In representative embodiments, the LIDAR devices can have configurations other than those specifically shown and described herein, including other semiconductor constructions. The optical devices described herein may have other configurations in other embodiments, which also produce the desired beam shapes and characteristics described herein.

Certain aspects of the technology described in the context of particular embodiments may be combined or eliminated in other embodiments. For example, aspects of the optical structure described in the context of FIGS. 6 and 7 may be applied to embodiments other than those specifically shown in the figures. Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein.

To the extent any materials incorporated herein conflict with the present disclosure, the present disclosure controls.

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. An unmanned movable object, comprising:
a main body;
a scanning element carried by the main body, the scanning element including:
a light emitting module positioned to emit light;
a light sensing module positioned to detect a reflected portion of the emitted light; and
an optical structure coupled to the light emitting module and positioned to increase a beam height of the emitted light while generally maintaining a beam width of the emitted light; and
a motion mechanism coupled between the main body and the scanning element, the motion mechanism operable to rotate the scanning element relative to the main body about a spin axis.

2. The object of claim 1, wherein the light sensing module includes a number of light sensors, and wherein the number of light sensors in the light sensing module is greater than a number of light emitters in the light emitting module.

3. The object of claim 1, wherein a heightwise field of view of an individual light sensor included in the light sensing module is narrower than the increased beam height of the emitted light.

4. The object of claim 1, wherein the optical structure comprises a plano concave cylindrical lens.

5. The object of claim 4, wherein the optical structure further comprises a plano convex lens situated between the plano concave cylindrical lens and the light emitting module.

6. The object of claim 5, wherein a flat side of the plano convex lens faces toward the light emitting module.

7. The object of claim 5, wherein the plano convex lens is positioned to collimate the light emitted from the light emitting module in a plane parallel to the main body but not in a plane perpendicular to the main body.

8. The object of claim 5, wherein a flat side of the plano concave cylindrical lens faces toward the light emitting module.

9. The object of claim 5, wherein the plano convex lens, the plano concave cylindrical lens, and the light emitting module are positioned to cause a virtual image point of the light emitting module, formed from the plano convex lens, to fall within a distance corresponding to a rear focal distance of the plano concave cylindrical lens.

10. The object of claim 1, wherein a heightwise beam angle of the emitted light is increased by the optical structure from about 1 degree to more than 30 degrees.

11.-13 (canceled)

14. The object of claim 1, wherein heightwise fields of view of multiple light sensors included in the light sensing module are arranged so as not to overlap each other.

15. (canceled)

16. The object of claim 1, wherein the scanning element is coupled to an actuator to spin at approximately 10 to 20 revolutions per second.

17.-27 (canceled)

28. The object of claim 1, further comprising:
a controller configured to maneuver the object in response to terrain or an obstacle detected by the scanning element; and
a plurality of thrusters carried by the main body and positioned to maneuver the object in response to inputs from the controller.

29.-31. (canceled)

32. A method of manufacturing an unmanned movable object, the method comprising:
installing a scanning element on a main body, the scanning element including:
a light emitting module positioned to emit light;
a light sensing module positioned to detect a reflected portion of the emitted light; and
an optical structure coupled to the light emitting module and positioned to increase a beam height of the emitted light while generally maintaining a beam width of the emitted light,
wherein installing the scanning element includes coupling a motion mechanism between the main body and the scanning element, the motion mechanism operable to rotate the scanning element relative to the main body about a spin axis.

33. The method of claim 32, further comprising:
placing a number of light sensors in the light sensing module; and
placing a number of light emitters in the light emitting module, wherein the number of light sensors in the light sensing module is greater than the number of light emitters in the light emitting module.

34.-49. (canceled)
